(19) United States
(12) Patent Application Publication
(10) Pub. No.: US 2011/0270823 A1
(43) Pub. Date: Nov. 3, 2011

(54) ACCELERATED RENDERING OF VIRTUAL VIEWS

(75) Inventors: John S. Roman, Lowell, MA (US); William A. Spencer, Westford, MA (US)

(73) Assignee: INTERNATIONAL BUSINESS MACHINES CORPORATION, Armonk, NY (US)

(21) Appl. No.: 12/771,066

(22) Filed: Apr. 30, 2010

(51) Int. Cl. G06F 17/30

(52) U.S. Cl. 707/722; 707/E17.014

(57) ABSTRACT

Systems and methods of generating virtual views may provide for identifying a first position in a first list based on a view selection such as a drag of a scroll bar. A plurality of remaining positions may be identified in a corresponding plurality of remaining lists based on the first position. In one example, the first position is used as a key to search each of the plurality of remaining lists. Solutions may also provide for generating a merged list view based on the first position and the plurality of remaining positions.

### BACKGROUND

1. Technical Field

Embodiments of the present invention generally relate to the generation of merged list views. More particularly, embodiments relate to a sequenced approach to identifying underlying list positions for merged list views.

2. Discussion

Certain computing environments may employ list browsing technology to display a list of information to a user in a relatively small window of a browser. Traditionally, the underlying data may be obtained from a single source such as a database, wherein upon detecting a scroll bar adjustment (e.g., user scrolls x % into the view), the browsing technology might construct an updated view from a page of data that is x % into the underlying list. More recently, however, the view may utilize data from multiple lists that might not be evenly distributed. Accordingly, additional processing time could be required to synchronize the retrieved page positions from each of the lists, which could have a negative impact on the user's browsing experience.

### BRIEF SUMMARY

Embodiments may provide for a method in which a first position in a first list is identified based on a view selection. A plurality of remaining positions can be identified in a corresponding plurality of remaining lists based on the first position. The method may also provide for generating a merged list view based on the first position and the plurality of remaining positions.

Embodiments may also provide for a computer program product comprising a computer readable storage medium and computer usable code stored on the computer readable storage medium. If executed by a processor, the computer usable code can cause a computer to identify a first position in a first list based on a view selection. The computer usable code may also cause a computer to identify a plurality of remaining positions in a corresponding plurality of remaining lists based on the first position, and generate a merged list view based on the first position and the plurality of remaining positions.

Other embodiments may provide for a computer program product comprising a computer readable storage medium and computer usable code stored on the computer readable storage medium. If executed by a processor, the computer usable code may cause a computer to obtain each of a first list and a plurality of remaining lists from a different source, and identify a first position in the first list based on a view selection. The computer usable code can also cause a computer to use the first position as a key to search each of the plurality of remaining lists, wherein the search is to identify a plurality of remaining positions corresponding to the plurality of remaining lists. In addition, the computer usable code may cause a computer to generate a merged list view based on the first position and the plurality of remaining positions, and send the merged list view to a user display associated with the view selection.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of a sequential scheme of generating merged list views according to an embodiment;

FIG. 2 is a flowchart of an example of a method of generating merged list views according to an embodiment;

FIG. 3 is a block diagram of an example of a process of generating a merged list view in response to a scroll bar drag according to an embodiment; and

FIG. 4 is a block diagram of an example of a computing environment according to an embodiment; and

FIG. 5 is a block diagram of an example of a computing system according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

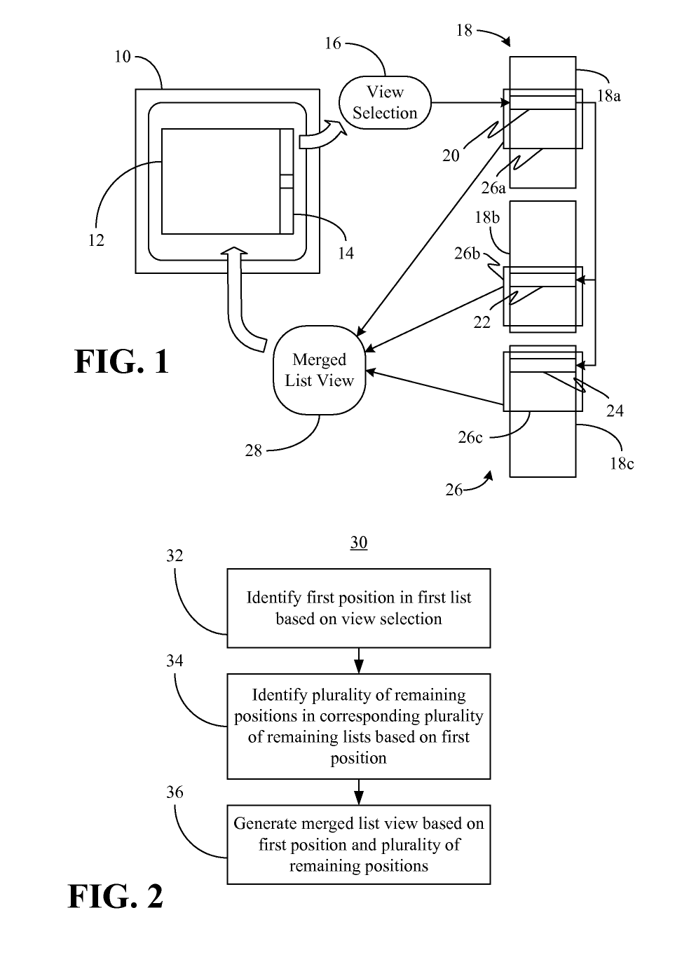

Referring now to FIG. 1, a scheme of generating merged (e.g., virtual) list views is shown. In the illustrated example, a display 10 presents a virtual view 12 to a user. The display 10 might be a monitor and/or screen of a computing system such as a desktop personal computer (PC), notebook computer, or netbook computer, and/or a mobile communication device such as a smart phone. The display 10 could also be a touch screen of a media player, an imaging device, etc., or any combination thereof. Generally, the user can make view selections 16 in order to view the underlying data, which may be obtained from a plurality of different sources. In the illustrated example, the virtual view 12 includes a scroll bar 14 that facilitates selection of different portions of the virtual view 12 by the user. The user may be able to manipulate the scroll bar 14 directly (e.g., if the display is a touch screen) or via another device such as a mouse or track ball (not shown).

In the illustrated example, the virtual view 12 presents a sorted list of data to the user, wherein the data is obtained from a plurality of lists 18 (18a-18c). The data might identify names, addresses (postal, email, Internet, etc.), phone numbers, product parts, financial transactions, and so on. In particular, the illustrated approach might be particularly advantageous when dealing with large amounts of data. Upon detection of a view selection 16, the illustrated approach identifies a first position 20 in a first list 18a (e.g., a “master” view list) based on the view selection 16. The first position 20 may then be used as a key to search each of the remaining lists 18b, 18c, wherein the search can identify remaining positions 22, 24, in the remaining lists 18b, 18c. A plurality of page views 26 (26a-26c) can then be obtained based on the first position 20 and remaining positions 22, 24, wherein the illustrated page views 26 are combined into a merged list view 28. For example, if the virtual view 12 displays ten lines at a time, ten lines may be retrieved from each list 18. Thus, for three lists 18, up to thirty lines might be merged together by selecting the first ten lines after sorting all thirty lines. In the illustrated example, the merged list view 28 is sent to the display 10 for presentation to the user.

The first list 18a may be selected from the plurality of lists 18 based on a number of considerations. For example, one approach may be to select the list with the most entries. Such a size-based approach could increase the likelihood of using an evenly distributed list as the master view. Another approach might be to conduct a spot sampling of the lists 18 to determine which one is most evenly distributed. Yet another approach could be to make the master view selection based on historical selection data so that the solution learns as the user browses. For example, the system might examine names as they are browsed and compare them with the position where the name is found and build up knowledge of which view to use as the master view. Alternatively, the master view might be predetermined and/or fixed prior to receipt of the view selection 16.

FIG. 2 shows a method 30 of generating virtual views. The method 30 could be implemented in executable software as a set of logic instructions stored in a machine- or computer-readable storage medium of a memory such as random access memory (RAM), read only memory (ROM), programmable ROM (PROM), flash memory, etc., as fixed-functionality hardware using circuit technology such as ASIC, complementary metal oxide semiconductor (CMOS) or transistor-transistor logic (TTL) technology, or any combination thereof. In one example, the method 30 is implemented as a browser plug-in.

Processing block 32 provides for identifying a first position in a first list based on a view selection. In particular, block 32 might involve navigating x % into the first list based on an approximate x % adjustment (e.g., “drag”) of the scroll bar. Block 34 provides for identifying a plurality of remaining positions in a corresponding plurality of remaining lists based on the first position. A merged list can be generated at block 36 based on the first position and the plurality of remaining positions.

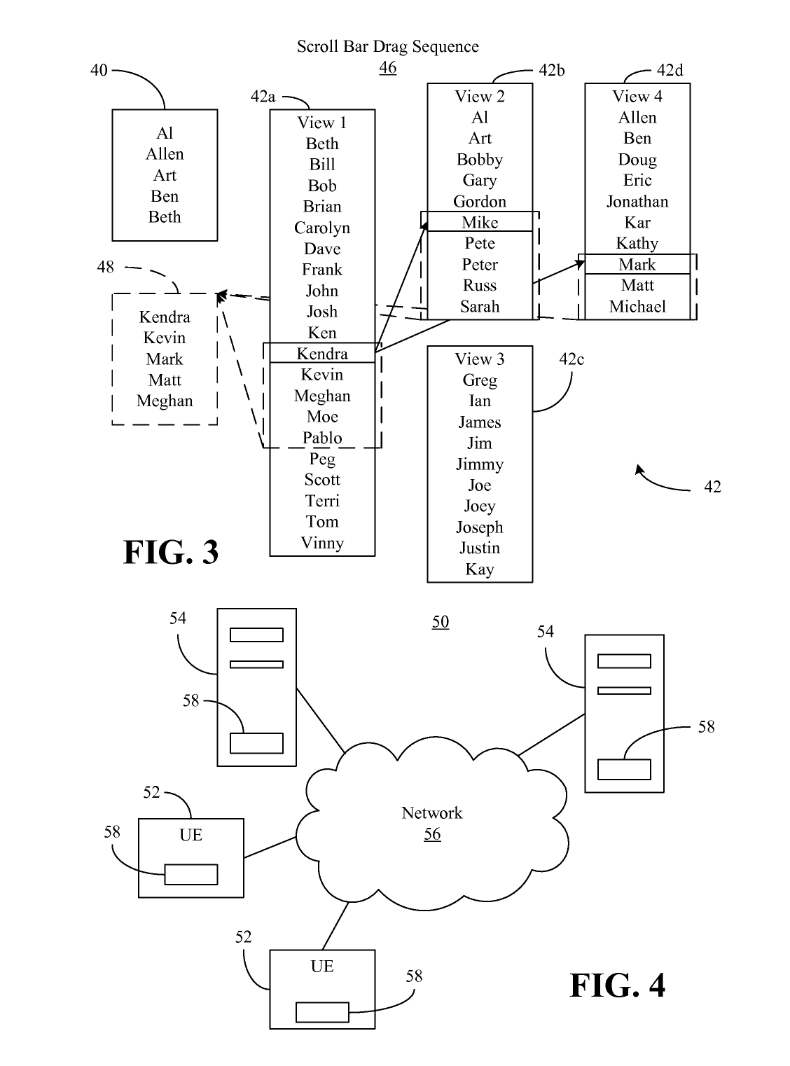

Turning now to FIG. 3, a sequence 46 of updating a virtual view 40 in response to a scroll bar drag to approximately fifty percent of the overall view is shown. Generally, a plurality of lists 42 (42a-42d; Views 1-4, respectively) from different sources can be presented in the virtual view 40. For example, the virtual view 40 might represent a company directory wherein each list 42 is a personnel database of a division of the company. In the illustrated example, the initial virtual view 40 shows a listing of names ranging from “Al” to “Beth”, wherein the underlying data is obtained from lists 42a (Beth), 42b (Al and Art), and 42d (Allen), sorted, and displayed in alphabetical order.

In this example, a search is conducted of the first view list 42a for the mid-point (e.g., fifty percent) of the data in the first view list 42a in response to the scroll bar drag. The search might return a first position “Kendra”, which may be used to search each of the remaining view lists 42b-42d. In the illustrated example, positions “Mike” in the second view list 42b and “Mark” in the fourth view list 42d are identified in the search. The third view list 42c, on the other hand may not contain any relevant data because there are no entries in that list alphabetically higher than Kendra. Thus, a page view may be taken from the first view list 42a (i.e., page containing Kendra to Pablo), a page view may be taken from second view list 42b (i.e., page containing Mike to Sarah), and a page view may be taken from the fourth view list 42d (i.e., page view containing Mark to Michael), wherein the illustrated page views are combined into the updated virtual view 48. In the example shown, none of the entries from the second view list 42b make it onto the updated virtual view 48 after sorting the three page views. Thus, the illustrated approach reduces processing overhead and enables efficient approximation of positions in virtual views, particularly if the lists are relatively large.

Turning now to FIG. 4, an architecture 50 is shown in which virtual views may be presented to individuals operating user equipment (UE) 52, servers 54, and/or other computing platforms. In the illustrated example, the UE 52, which can include web browsing capability, may be a personal computer (PC), notebook computer, personal digital assistant (PDA), wireless smartphone, or other device having access to the servers 54, via a network 56. The UE 52 connections to the network 56 may include a wireless data connection (e.g., IEEE 802.11, 1999 Edition, LAN/MAN Wireless LANS (WiFi), IEEE 802.16-2004, LAN/MAN Broadband Wireless LANS (WiMAX), etc.), a cellular telephone connection (e.g., W-CDMA (UMTS), CDMA2000 (IS-856/IS-2000), etc.), a wired data connection (e.g., RS-232 (Electronic Industries Alliance/EIA), Ethernet (e.g., IEEE 802.3-2005, LAN/MAN CSMA/CD Access Method), power line communication (e.g., X10, IEEE P1675), USB (e.g., Universal Serial Bus 2.0 Specification)), etc., depending upon the circumstances. The UE 52 devices could be located in the same physical location or in different locations.

In addition, the network 56 can include any suitable combination of servers, access points, routers, base stations, mobile switching centers, public switching telephone network (PSTN) components, etc., to facilitate communication between the UE 52 and the servers 54. The servers 54, which might support a wide variety of database management, e-commerce transactions and other activities, may include distributed and/or redundant web-based servers that are able to respond to web page requests for content. Thus, the servers 54 can have stored thereon hypertext markup language (HTML) and other markup language-encoded content, as well as databases and applications such as Java and other applications. The servers 54 could also be part of a cloud computing environment in which resources are shared across platforms in a complex fashion. In the illustrated example, the UE 52 and servers 54 include virtual view acceleration logic 58 capable of rendering merged view lists that are based on data from a plurality of sources. In particular, the logic 58 can be configured to identify a first position in a first list based on a view selection, identify a plurality of remaining positions in a corresponding plurality of remaining lists based on the first position, and generate a merged list view based on the first position and the plurality of remaining positions, as already discussed.

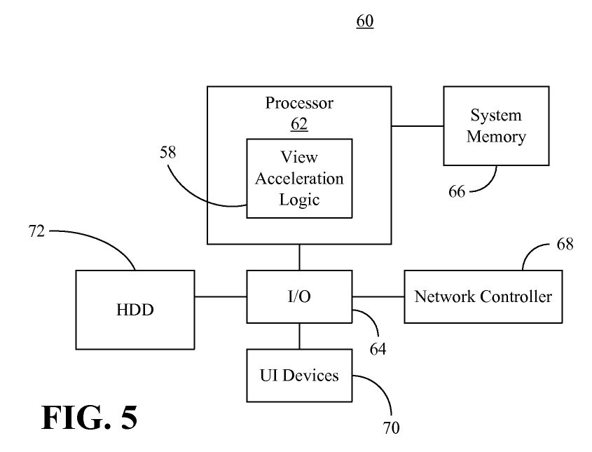

Turning now to FIG. 5, a platform 60 is shown. The illustrated platform may be part of a computing system, wireless communication device, media player, imaging device, etc., or any combination thereof. In particular, the platform 60 may include a processor 62 coupled to an input/output (I/O) interface/device 64 and system memory 66, a network controller 68, user interface (UI) devices 70 (e.g., browser, display, keypad, mouse, etc. in order to allow a user to interact with and perceive information from the platform), and a computer readable storage medium such as a hard disk drive (HDD) 72, solid state disk (SSD), etc. The system memory 66 may be configured as dynamic random access memory (DRAM) modules that could be incorporated into a single inline memory module (SIMM), dual inline memory module (DIMM), small outline DIMM (SODIMM), and so on.

In one example, the processor 62 executes view acceleration logic 58 retrieved from the system memory 66, internal or external caches, or other computer readable storage media such as HDD 72. The view acceleration logic 58 may include functionality to render merged view lists that are based on data from a plurality of sources, already discussed. The network controller 68 connection to the data sources might include a wireless data connection (e.g., IEEE 802.11, 1999 Edition, LAN/MAN Wireless LANS (WiFi), IEEE 802.16-2004, LAN/MAN Broadband Wireless LANS (WiMAX), etc.), a cellular telephone connection (e.g., W-CDMA (UMTS), CDMA2000 (IS-856/IS-2000), etc.), a wired data connection (e.g., RS-232 (Electronic Industries Alliance/EIA), Ethernet (e.g., IEEE 802.3-2005, LAN/MAN CSMA/CD Access Method), power line communication (e.g., X10, IEEE P1675), USB (e.g., Universal Serial Bus 2.0 Specification)), etc., depending upon the circumstances.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. are used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer program product comprising:
a computer readable storage medium; and
computer usable code stored on the computer readable storage medium, where, if executed by a processor, the computer usable code causes a computer to:
obtain data for each of a first list and a plurality of remaining lists from a different source;
identify a first position in the first list based on a view selection;
use the first position as a key to search each of the plurality of remaining lists, wherein the search is to identify a plurality of remaining positions corresponding to the plurality of remaining lists;
generate a merged list view based on the first position and the plurality of remaining positions; and
send the merged list view to a user display associated with the view selection.

2. The computer program product of claim 1, wherein the computer usable code, if executed, further causes a computer to:
obtain a plurality of page views based on the first position and the plurality of remaining positions; and
combine the plurality of page views into the merged list view.

3. The computer program product of claim 1, wherein the computer usable code, if executed, further causes a computer to select the first list based on at least one of a size of the first list, a distribution evenness of the first list, and historical selection data.

4. The computer program product of claim 1, wherein the view selection is to correspond to a scroll bar adjustment.

5. A computer program product comprising:
a computer readable storage medium; and
computer usable code stored on the computer readable storage medium, where, if executed by a processor, the computer usable code causes a computer to:
identify a first position in a first list based on a view selection;
identify a plurality of remaining positions in a corresponding plurality of remaining lists based on the first position; and
generate a merged list view based on the first position and the plurality of remaining positions.

6. The computer program product, wherein the computer usable code, if executed, causes a computer to use the first position as a key to search each of the plurality of remaining lists.

7. The computer program product of claim 6, wherein the computer usable code, if executed, causes a computer to obtain data for each of the first list and the plurality of remaining lists from a different source.

8. The computer program product of claim 5, wherein the computer usable code, if executed, causes a computer to:
obtain a plurality of page views based on the first position and the plurality of remaining positions; and
combine the plurality of page views into the merged list view.

9. The computer program product of claim 8, wherein the computer usable code, if executed, causes a computer to send the merged list view to a user display associated with the view selection.

10. The computer program product of claim 5, wherein the computer usable code, if executed, causes a computer to select the first list based on a size of the first list.

11. The computer program product of claim 5, wherein the computer usable code, if executed, causes a computer to select the first list based on a distribution evenness of the first list.

12. The computer program product of claim 5, wherein the computer usable code, if executed, causes a computer to select the first list based on historical selection data.

13. A method comprising:
identifying a first position in a first list based on a view selection;
identifying a plurality of remaining positions in a corresponding plurality of remaining lists based on the first position; and
generating a merged list view based on the first position and the plurality of remaining positions.

14. The method of claim 13, wherein identifying the plurality of remaining positions includes using the first position as a key to search each of the plurality of remaining lists.

15. The method of claim 14, further including obtaining data for each of the first list and the plurality of remaining lists from a different source.

16. The method of claim 13, wherein generating the merged list view includes:
obtaining a plurality of page views based on the first position and the plurality of remaining positions; and
combining the plurality of page views into the merged list view.

17. The method of claim 16, further including sending the merged list view to a user display associated with the view selection.

18. The method of claim 13, further including selecting the first list based on a size of the first list.

19. The method of claim 13, further including selecting the first list based on a distribution evenness of the first list.

20. The method of claim 13, further including selecting the first list based on historical selection data.
